(19) United States
(12) Patent Application Publication
(10) Pub. No.: US 2009/0228280 A1
(43) Pub. Date: Sep. 10, 2009

(54) TEXT-BASED SEARCH QUERY FACILITATED SPEECH RECOGNITION

(75) Inventors: Kyle Oppenheim, Mountain View, CA (US); David Mitby, Mountain View, CA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/043,085

(22) Filed: Mar. 5, 2008

(51) Int. Cl. G10L 21/00

(52) U.S. Cl. 704/275

(57) ABSTRACT

Systems and methods for text-based search query facilitated speech recognition are disclosed. In one aspect of the present disclosure, a number of text-based search queries (e.g., search terms) are identified and logged such that variations (e.g., reference variations) of such search terms can be created. Reference variations of a search term refer generally to a broad set of analogous or related words or concepts. In a further aspect of the present disclosure, multiple search results are presented in response to a text-based search query (e.g., search term). The search results presented in response to the query are recorded and stored. In most instances, the search results presented to text-based search queries can be created as reference variations for the search term.

### TECHNICAL FIELD

This disclosure relate generally to speech recognition and, more particularly, to providing speech recognition results based on text-based queries.

### BACKGROUND

Interactive voice response systems can provide information in response to a voice input from a user. Such information may include business listings or other types of information including but not limited to, ticketing information, traffic data, concert information, weather reports, songs, stock information, sports information, etc.

For example, in response to receiving a voice based query from a user regarding a business listing, an interactive voice response system may search a database of business listings and provide one or more matching results (e.g., a listing that most closely matches the speech input) to the user as the speech recognition result.

However, the user submitted audio input (e.g. voice speech recording) may not match the name of the listing word-for-word causing a potential discrepancy in the retrieved information versus the desired information. In some instances, the speech input may be inherently incomplete thus partially matching a number of business listings which may be inaccurate.

Further discrepancies may exist between voice input submitted by the user and result of voice input from speech processing. This potential source of error may further prohibit the ability of the interactive voice response system to provide accurate results.

### SUMMARY OF THE DESCRIPTION

Systems and methods for text-based search query facilitated speech recognition are described here. Some embodiments of the present disclosure are summarized in this section.

In one aspect of the present disclosure, multiple text-based search queries (e.g., search terms) are identified and logged such that variations (e.g., reference variations) of such search terms can be created. Reference variations of a search term refer generally to a broad set of analogous and/or related words, concepts and similar target references.

Generally, a search term can be associated with a set of variations. For example, the text-based search term ‘pizza’ may have associated with it, reference variations such as, ‘Pizza my Heart’, ‘Pizza Hut’, ‘Domino's Pizza’, etc. In another example, the text-based search term ‘Safeway’ may have associated with it, reference variations such as, ‘Safeway Supermarket’ and/or ‘Safeway Gas Station’. These variations associated with a particular search term are, in one embodiment, determined from compilations of the received text-based search queries submitted by users. For example, when a user submits the text ‘pizza’ and subsequently identifies ‘Pizza My Heart’ as the intended target query, the system adds ‘Pizza My Heart’ as a variation (reference variation).

In a further aspect of the present disclosure, multiple search results are presented in response to a text-based search query (e.g., search term). The search results presented in response to the query are recorded and stored. In most instances, the search results presented to text-based search queries can be created as reference variations for the search term. Additionally, the search result that was selected and/or further inquired by the user is recorded thus the frequency with which each result is selected can be determined. Selection frequency of each result can be used to rank or otherwise weigh the reference variations. The weight may be used as an indicator of likelihood that a user intends to make an inquiry for a particular listing in the search results when a particular search term is used.

In one aspect, the created reference variations (which may be ranked or un-ranked) for a particular search term is used for intelligently responding to a voice-based request and enhancing the accuracy of the results provided in response to the search term. For example, a search term may be submitted via audio (e.g., voice) rather than text. Speech recognition may be performed on the received audio (voice) input to identify or retrieve the search term or parts of a search term used. The search term identified from speech recognition of the voice input can be used to retrieve the set of reference variations created for the particular search term. One or more results from the reference variations may be pre-selected for the user, for example, based on the relevant rankings or weights. When a user performs a voice search, a server may use information from prior text-search queries to select the results provided to the user this enhancement may allow improved accuracy/precision in the results being provided to the user.

In yet a further aspect of the present disclosure, grammar entries are created based on the text-based search queries and the related information thereof. For example, for each search query, geographical information in addition to the created reference variations may be stored as a grammar entry. The grammar entries may further be utilized as a database from which speech recognition results may be obtained.

The present disclosure includes methods and systems which perform these methods, including processing systems which perform these methods, and computer readable media which when executed on processing systems cause the systems to perform these methods.

Other features of the present disclosure will be apparent from the accompanying drawings and from the detailed description which follows.

### BRIEF DESCRIPTION OF THE DRAWINGS

FIG. 1 illustrates a block diagram of a plurality of client devices coupled to one another and a host server that facilitates speech recognition from collective text-based search queries among users of the plurality of client devices via one or more networks.

FIG. 2 depicts a block diagram illustrating a system to facilitate speech recognition from text-based search queries, the system to include a grammar module, a speech recognition module, and/or a search engine.

FIG. 3 is a diagrammatic representation of how a voice user and a text user interacts with the system to obtain enhanced speech recognition results from text-based search queries.

FIG. 4 depicts a block diagram illustrating example components of the host server.

FIG. 5 illustrates a diagrammatic representation of the contents of a database for storing reference variables and search terms (e.g. text-based search queries).

FIG. 6 depicts a flow diagram illustrating a process of creating reference variations from text-based search queries.

FIG. 7 depicts a flow diagram illustrating a process of providing enhanced search results by performing speech recognition and obtaining recognition results from grammar entries.

FIG. 8A illustrates a diagrammatic representation of the contents of another example database for storing reference variables and search terms.

FIG. 8B illustrates a diagrammatic representation of ranking/weighing of reference variations based on a search log.

FIG. 8C illustrates a diagrammatic representation of the contents of another example database for storing reference variables and search terms.

FIG. 9A-D illustrate diagrammatic representations user of triggered access and interaction with an example database having a plurality of grammar entries.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

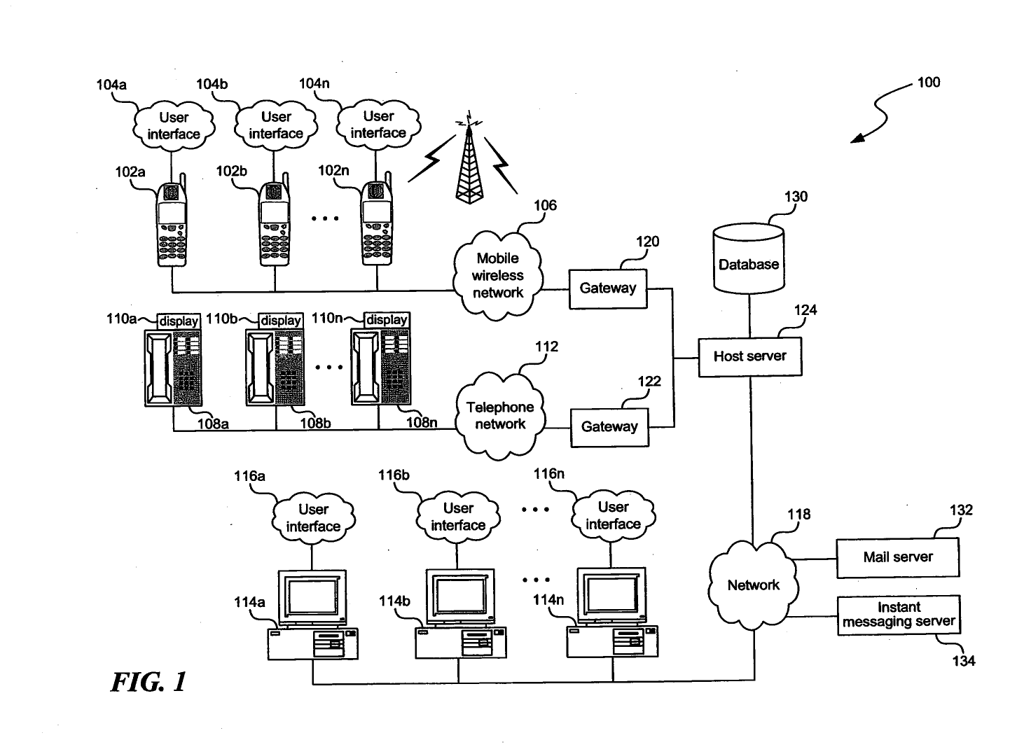

FIG. 1 illustrates a block diagram of a plurality of client devices 102A-N, 108A-N, 114A-N coupled to one another and a host server 124 that facilitates speech recognition based on text-based queries among users of the plurality of client devices via one or more of a mobile wireless network 106, telephone network 112, and/or network 118, according to one embodiment.

The plurality of client devices (e.g., mobile devices) 102A-N can be any system and/or device, and/or any combination of devices/systems that is able to establish a connection with a wireless network (e.g., mobile wireless network 106). The mobile devices 102A-N typically include a screen or other output display functionalities to present data exchanged between the devices to a user, such as to display user interfaces 104A-N. For example, the mobile devices 102A-N can be, but are not limited to, a mobile computing device, a mobile phone, a cellular phone, a VoIP phone, a smart phone, a PDA, a Blackberry device, a Treo, and/or an iPhone, etc.

The plurality of telephonic devices 108A-N can be any system and/or device, and/or any combination of devices/systems that is able to establish a connection with a telephone network 112. The telephonic devices 108A-N typically include a screen 110A-N or other output display functionalities to present data exchanged between the devices to a user, such as to display system or call status. For example, the mobile devices 102A-N can be, but are not limited to, a wired or wireless telephone, a fax machine, an answering machine, mobile phone, a cellular phone, a landline phone, a satellite phone, a PBX phone, a VoIP phone, a smart phone, a PDA, a Blackberry device, a Treo, an iPhone, and/or any other type of communication device able to provide voice communication and/or touch-tone signals over the telephone network 112. In addition, any audio signal carrying interface can be used.

The client devices 114A-N can be any system and/or device, and/or any combination of devices/systems that is able to establish a wired or wireless connection with another device, servers and/or other systems in some instances via a network (e.g., network 118). The client devices 114A-N may also include a screen or other output display functionalities to present data exchanged between the devices to a user, such as, to display user interfaces 116A-N. For example, the client devices 114A-N can be, but are not limited to, a processing unit, a server desktop, a desktop computer, a computer cluster, a mobile computing device such as a notebook, a laptop computer, a handheld computer, a mobile phone, a smart phone, a PDA, a Blackberry device, a VoIP phone, a Treo, and/or an iPhone, etc.

In one embodiment, the mobile devices 102A-N, the telephonic devices 108A-N and client devices 114A-N are coupled via a mobile wireless network 106, gateways 120/122 and the network 118. The host server 124 can be coupled to the mobile devices 102, telephonic devices 108, and the client devices 114 via one or more of the mobile wireless network 106, the telephone network 112, and the network 118.

For example, the wireless network (e.g., mobile wireless network) 106 can be any network able to establish connections with mobile devices 102A-N, such as mobile phones. The wireless network 110 can be, but is not limited to Global System for Mobile Communications (GSM) network, Code Division Multiple Access (CDMA) network, Evolution-Data Optimized (EV-DO) network, Enhanced Data Rates for GSM Evolution (EDGE) network, 3GSM network, Fixed Wireless Data, 2G, 2.5G, 3G networks, enhanced data rates for GSM evolution (EDGE) network, General packet radio service (GPRS) network, enhanced GPRS network, Digital Enhanced Cordless Telecommunications (DECT), Digital AMPS (IS-136/TDMA) network, and Integrated Digital Enhanced Network (iDEN).

GSM networks typically provide wireless service providers with the ability to offer roaming services to subscribers when they travel outside of the region (e.g., country) where subscription is based. Communication services provided by the wireless network 106 may further support messaging protocols such as, but is not limited to, Multimedia Messaging Service (MMS), SMS, USSD, IRC, or any other wireless data networks and/or messaging protocols.

In particular, GSM networks typically offer Short message service (SMS), or text messaging services to subscribers, thus allowing, for example, mobile device users (e.g., users of mobile devices 102A-N) to send text messages to one another. SMS is typically supported by mobile standards such as ANSI CDMA networks, 3G, AMPS, satellite, and/or landline networks. The Short Message Service—Point to Point (SMS-PP) is defined in the GSM recommendation 3GPP TS 23.040/3GPP TS 23.041 and is incorporated herein by reference.

In addition to messaging between mobile device users, messages (e.g., ads, public messages) can be broadcasted to mobile devices within a geographical region. SMS messages sent from a mobile device can be forwarded to Short Message Service Centers (SMS-C) which can store and/or forward the text message to a recipient. If the recipient mobile device cannot be reached or is not available, the SMS-C can store the message in a queue to be sent later. In some instances, the SMS-C attempts transmission once and does not store unsent messages in a queue for later retry. In some situations, a user may request delivery reports to receive a confirmation when a text message has been delivered to the receiving mobile device.

Typically, the transmission of text messages between the mobile device and the SMS-C is managed by the Mobile Application Part (MAP) of the SS7 protocol. The MAP specification is described in 3GPP TS 29.002 and the contents are incorporated herein by reference. MAP allows various communications networks (e.g., GSM, UMTS mobile core networks, GPRS core networks, etc.) to interact with one another to deliver services to mobile devices. In addition to SMS, the applications facilitated by MAP include, by way of example but not limitation, mobility services for location management and authentication, operation and maintenance, call handling, supplementary services, Packet Data Protocol (PDP) services for GPRS, and/or location service management services.

The SS7 protocol is a standard described by the ITU Telecommunication Standardization Sector (ITU-T) and includes functions such as, but is not limited to, Message Transfer Part (MTP) to provide transfer an delivery of signaling information across networks, Signaling Connection Control Point (SCCP) to provide routing capabilities via SubSystem Numbers (SSNs), ISDN User Part (ISUP) to provide transport of call set-up information between signaling points, Interconnect User Part (IUP) to support customer services and network features at point of interconnect between pubic networks, Transaction Capability Application Part (TCAP) to provide capability of transferring non-circuit-related information between signaling points, and Telephone User Part (TUP) to provide transport of call set-up information between signaling points for voice services, etc.

In addition, GSM provides Unstructured Supplementary Service Data (USSD) capabilities to mobile devices to support transmission of information over signaling channels of the GSM network. USSD is a communications technology that can be used to send data (e.g., text) between a mobile device and an application program in the network. USSD is defined in the GSM standard in GSM 02.90 (USSD Stage 1), GSM 03.90 (USSD Stage 2), and GSM 04.90; the contents are herein incorporated by reference. USSD Phase 1 in general supports mobile-initiated operations (as opposed to network-initiated operations).

Therefore, the mobile device can send a USSD command to the network and receive a response. In other words, a USSD Phase 1 communication session typically comprises one request and one answer (e.g., one USSD transaction). With USSD Phase 2, a dialogue can generally be established between the mobile device and the wireless network. Multiple USSD operations can typically be sent within a communication session. In addition, the dialogue with USSD Phase 2 can be network (application)-initiated or mobile station-initiated.

In most instances, USSD can provide a text-based, bidirectional, interactive, and session-oriented channel of communication between mobile devices and servers in the Home Public Land Mobile Network (HPLMN) and the Visited Public Land Mobile Network (VPLMN) of mobile subscribers. USSD messaging service is typically session-based thus resulting in faster response times compared to messaging services that are store-and-forward services such as SMS. Thus typically, once a USSD command/message has been sent to a service provider, a response can be received within a few seconds. In some applications, a USSD command is sent to query available balance and/or call logs in pre-paid GSM services. The mobile device user can, in some instances, communicate with a wireless application provided by the wireless service provider (e.g., operator) in a manner that is transparent to the mobile device and intermediate network entities.

The telephone network 112, can by any network able to establish connections with one or more telephone devices 108a-N through any known and/or convenient telephonic protocol. For example, the telephone network 112 can be, but is not limited to, the public switched telephone network (PSTN), the integrated services digital network (ISDN), asymmetric digital subscriber line (ADSL), digital subscriber line (DSL) and/or some other type of telephone network. The telephone network 112 generally represents an audio signal carrying network. Telephonic devices can digitally transmit speech, sound, touch-tone signals, and/or other types of data over the telephone line. The PSTN is largely governed by technical standards created by the ITU-T, and uses E.163/E.164 addressing and is incorporated herein by reference.

The network 118, over which the client devices 114A-N communicate, may be a telephonic network, an open network, such as the Internet, or a private network, such as an intranet and/or the extranet. In addition, the network through which IM servers (e.g., IM server 134) provide services to client devices may be a telephonic network, an open network, such as the Internet, or a private network, such as an intranet and/or the extranet.

The client devices 114-N can be coupled to the network (e.g., Internet) via a dial up connection, a digital subscriber loop (DSL, ADSL), cable modem, and/or other types of connection. Thus, the client devices 114A-N can communicate with remote servers (e.g., web server, host server, mail server, instant messaging server) that provide access to visual interface to the World Wide Web via a web browser, for example.

For example, the Internet can provide file transfer, remote log in, email, news, RSS, and other services through any known and/or convenient protocol, such as, but is not limited to the TCP/IP protocol, Open System Interconnections (OSI), FTP, UPnP, iSCSI, NSF, ISDN, PDH, RS-232, SDH, SONET, etc. In some embodiments, the network 118 can be any collection of distinct networks operating wholly or partially in conjunction to provide connectivity to the client devices, host server, and/or the content providers and may appear as one or more networks to the serviced systems and devices. In one embodiment, communications can be achieved by a secure communications protocol, such as secure sockets layer (SSL), or transport layer security (TLS).

In addition, communications can be achieved via one or more wired and/or wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Bluetooth, Wi-Fi, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The gateways 120 and 122, typically interfaces the mobile wireless network 106 and the telephone network 112 to another network (e.g., network 118) that utilizes one or more different protocols. The gateways 120 and 122 can communicate with one or more components having any combination of software agents and/or hardware modules for facilitating a mobile device operator (e.g., a user of mobile devices 102A-102N) and the telephone operator (e.g., a user of telephone devices 108A-N) to communicate with a client device user (e.g., a user of client devices 108A-N) through a mobile wireless network (e.g., the wireless network 106), a telephone network (e.g., the telephone network 112), and the network 118.

The gateways 120 and 122 can include a number of components such as, but is not limited to, protocol transistors, impedance matching devices, rate converters, fault isolators, and/or signal translators, etc., to interface to one or more networks with different protocols than the protocols under which the original signal was sent. The gateways 120 and 122 can further facilitate the establishment of a set of rules and administrative procedures between different network protocols such that communication can be established. Typically, protocol converters such as gateways can operate at any network layer (e.g., the application layer, the presentation layer, the session layer, the transport layer, the network layer, the data link layer, and/or the physical layer) of the Open System Interconnection (OSI) model and convert one protocol stack into another. For example, a gateway can connect a LAN to the Internet. Similarly, gateways can also connect two IP-based networks.

In some embodiments, the gateways 120 and/or 122 are any combination of hardware modules and software agents able to convert an SMS message to the TCP/IP standard. In one embodiment, connection between the SMS-C and the Internet and/or other TCP/IP-based networks can be established via the SMPP protocol provided by the gateway. The gateway may further be connected to the IM server 134 through a TCP/IP network. In one embodiment, the gateway is connected to the IM server 134 via the XMPP protocol, which is typically compatible with real-time or near-real-time communications and managing presence information of subscribers.

RFC 821 published by the Internet Engineering Task Force (IETF) describes the Simple Mail Transport Protocol (SMTP) the contents of which are herein incorporated by reference. RFC 1459 published by IETF describes the Internet Relay Chat (IRC) protocol, a system for text-based conferencing in TCP/IP networks, the contents of which are herein incorporated by reference. RFC 3920, 3921, 3922 and 3923 published by IETF describe the Extensible Messaging and Presence Protocol (XMPP), a protocol for “instant messaging” (IM) applications in TCP/IP networks, the contents of which are herein incorporated by reference.

In one embodiment, the host server 124 is coupled to a mail server 132 over the network 118. The mail server 214 includes software agents and/or hardware modules for managing and transferring emails from one system to another, such as but is not limited to Sendmail, Postfix, Microsoft Exchange Server, Eudora, Novell NetMail, and/or IMail, etc. The mail server 132 can also store email messages received via the network. In one embodiment, the mail server 132 includes a storage component, a set of access rules which may be specified by users, a list of users and contact information of the users' friends, and/or communication modules able to communicate over a network with a predetermined set of communication protocols.

The database 130 can store software, descriptive data, images, system information, drivers, and/or any other data item utilized by other components of the host server 124 and/or any other servers for operation. The database 130 may be managed by a database management system (DBMS), for example but not limited to, Oracle, DB2, Microsoft Access, Microsoft SQL Server, PostgreSQL, MySQL, FileMaker, etc.

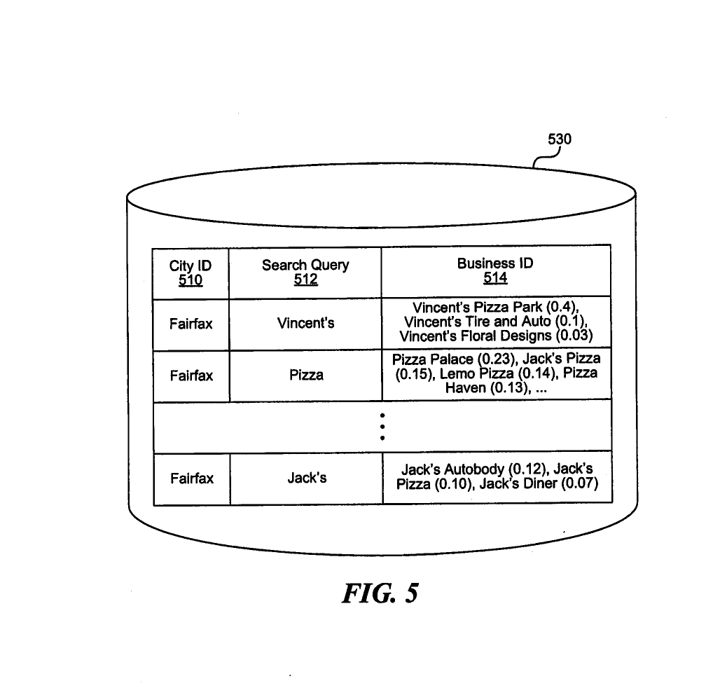

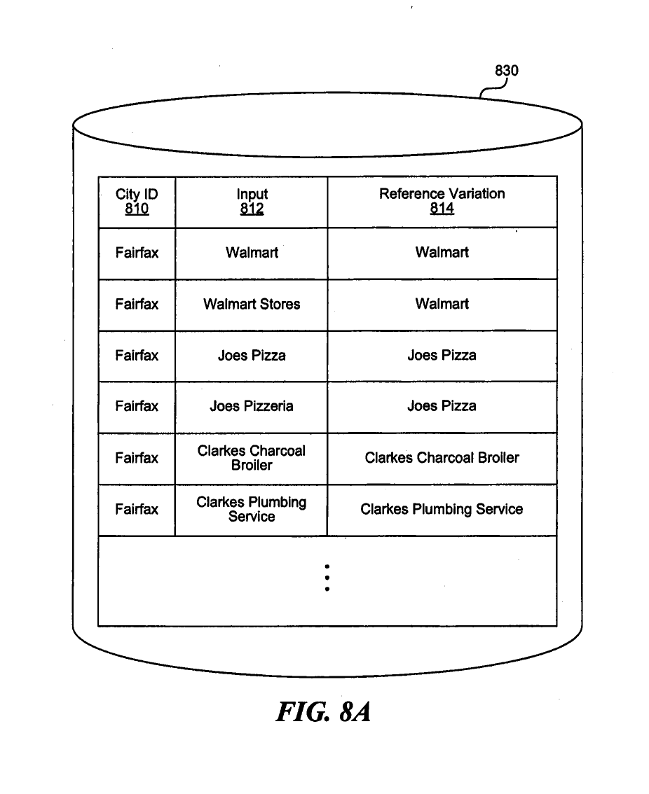

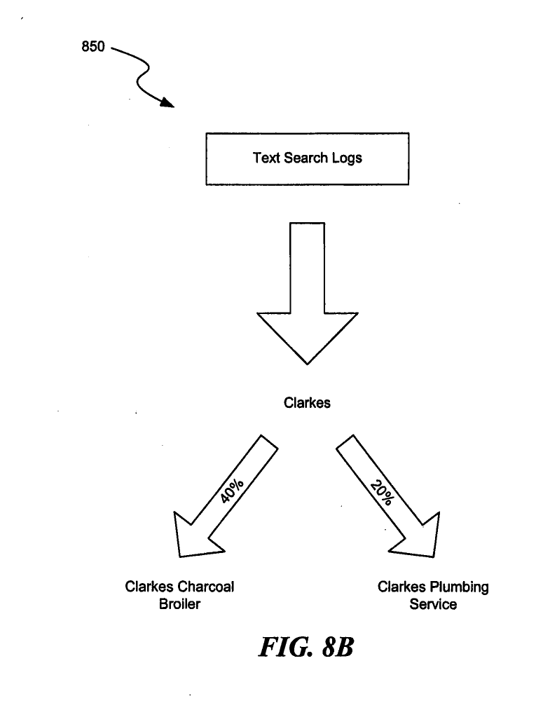

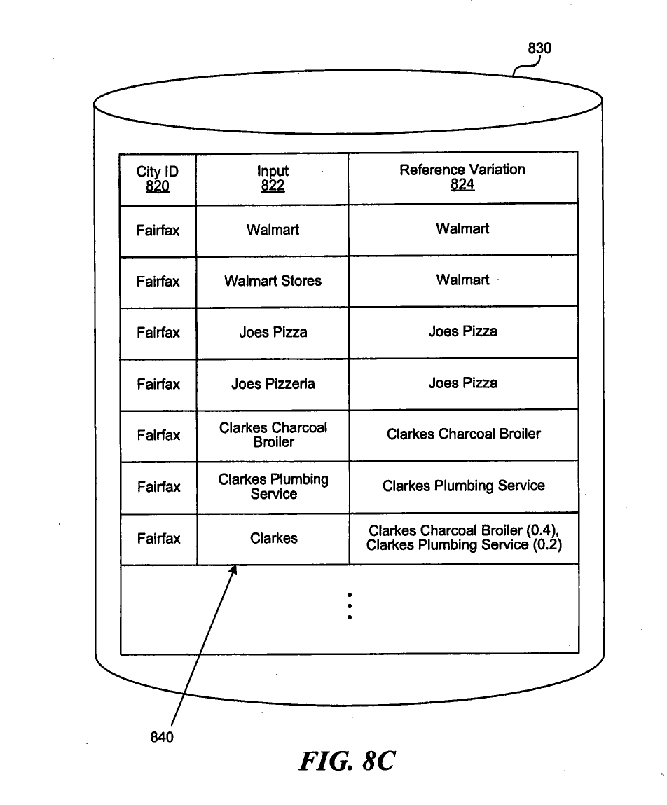

The database 130 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. An example set of data to be stored in the database 130 is further illustrated in FIG. 5 and FIG. 8.

The host server 124 is, in some embodiments, able to communicate with cell phone devices 102A-N via the mobile wireless network 106, telephone devices 108A-N via the telephone network 112, and/or client devices 114A-N via the network 118. In some embodiments, the host server 124 is able to provide data to be stored in the database 130 and/or to retrieve data stored in the database 130.

The communications that the host server 124 establishes with the client-end devices can be multi-way and via one or more different protocols. Any number of communications sessions may be established prior to or while compiling text-based search queries and analyzing the compilation to generate reference variations. Further, multiple communication sessions may be established when receiving voice input for speech analysis for matching to reference variations. Each session may involve multiple users communicating via same or different protocols. For example, a user may be chatting via instant messaging, another over VoIP, and yet another over SMS.

The host server 124 can receive queries in text and/or audio, in series and/or in parallel to for logging purposes and/or for further analysis. In addition, the host server 124 can establish communication sessions with the database 130 to identify additional information about past queries, such as, but not limited to geographical location, user preferences, reference variations, common search terms, similar search terms, etc.

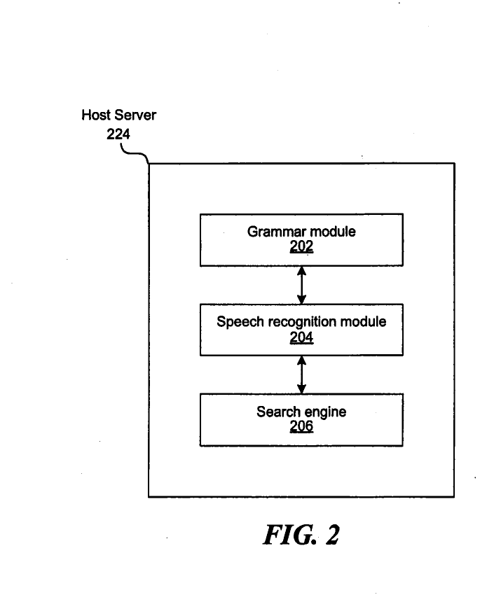

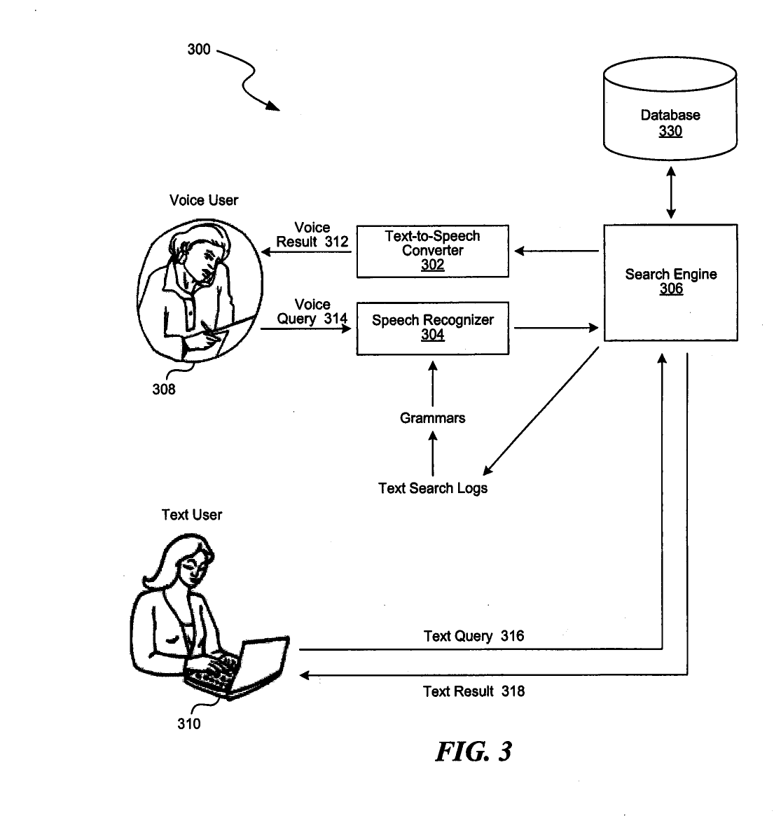

The host server 124 may also obtain information about business listings and the reference variations related to thereof, via communicating with the database 130. For example, information regarding, the location of the business listing, the search terms (text or audio based), and/or hours of operation of the business, can be obtained. Additional functionalities of the host server are described with further reference to FIG. 2-3.

The instant messaging server 134, can establish connections with one or more of the client devices 114A-N through any known and/or convenient protocol, such as, but is not limited to Session Initiation Protocol (SIP), SIP for Instant Messaging and Presence Leveraging Extensions (SIMPLE), Application Exchange (APEX), real time messaging protocol (RTMP), Presence and Instant Messaging Protocol (Prim), Extensible Messaging and Presence Protocol (XMPP), instant messaging and presence protocol (IMPP), Open Mobile Appliance (OMP), Instant Messaging and Presence Service (OMP), etc.

IM service providers that provide the IM services which can be accessed by mobile devices over a wireless network, can include, but are not limited to, AIM, Jabber, EBuddy, Windows Messenger, Yahoo! Messenger, QQ, Skype, Sametime, Xfire, ICQ, Gadu-Gadu, Paltalk, MXit, PSYC, Meebo, etc. The IM server 134 (e.g., a Jabber/XMPP server) can provide and manage one or more of the above mentioned protocols (e.g., SIP, OMP, XMPP) to provide access to the instant messaging network by allowing various IM software clients (e.g., Gabber, Exodus, Google Talk, etc.) to utilize the protocols to provide connectivity to end users (e.g., client devices 106A-106N).

FIG. 2 depicts a block diagram illustrating a host server 224 to facilitate speech recognition from text-based search queries, the system to include a grammar module 202, a speech recognition module 204, and/or a search engine 206.

The grammar module 202 is any combination of hardware modules and/or software agents able to generate, create, modify, update, and/or store grammars. In general, a grammar entry is associated with textual data (e.g. text-based search query) submitted by a user via text input or recognized speech data received from a user via voice input. In some embodiments, a grammar entry is created based on data submitted by multiple users.

In one embodiment, the grammar entry includes reference variations that are created from logs generated from compilations of text-based search queries. The reference variations can be stored in the grammar module 202 as a part of a grammar entry. For example, if a log of text-based search queries indicate that text queries (e.g., search term) for “Dave's” in “Fairfax, Va.” are more frequently looking for “Famous Dave's”, the grammar entry associated with the query “Dave's” may weigh “Famous Dave's” more heavily than other business listings or services having the same or similar terminology as “Dave's” in Fairfax, Va.

Speech recognition module 204 is any combination of hardware modules and/or software agents able to receive audio signal (e.g., speech or voice from a user) and perform a speech recognition operation to convert the audio data to a textual data, for example, as a recognition word/phrase. Any convenient and/or known speech recognition methods and any combination thereof may be utilized. The speech recognition methods which may be used include by way of example but not limitation, acoustic and/or language modeling, Hidden Markov model (HMM), and/or dynamic time warping (DTW) based recognition.

In one embodiment, speech recognition module 204 is able to communicate with the grammar module 202 to use grammar entries to facilitate the speech recognition operation. For example, speech recognition module 204 may send textual data including a recognition word/phrase to the grammar module 202. The grammar module 202 can analyze the grammar entries and provide one or more reference variations to the speech recognition module 204. The reference variation may be used by server 224 to obtain information for a requesting client who submitted the text and/or audio inquiry.

In one embodiment, the grammar module 202 receives a recognition result from speech recognition module 204 and provides a one or more reference variations based on the recognition result. A grammar entry may, in some embodiments, be associated with a set of users, associated with a select group of users, and/or associated with individual users. For example, an individual user's logs of text-based inquiries may be used to create one or more grammar entries for that particular user. The grammar entries may include a weight or rank of reference variations based on the user's logs of text-based inquiries. When the user submits a voice input to perform a voice inquiry for a business listing and/or services for which a grammar entry has been created, the reference variations may be provided to search engine 206.

The search engine 206 is any combination of hardware modules and/or software agents able to create, modify, update, store, query, and/or retrieve the reference variations that associate grammar entries with data sets (e.g., information related to business listings and/or services). In one embodiment, the set of business listings corresponding to reference variations are ranked or otherwise weighted. The ranking/weighting of reference variations is generally intended to reflect the probability (e.g., qualitative and/or quantitative) that a particular search term is to locate a particular business listing associated with a particular reference variation.

The set of business listings (and the weight or rank associated with each reference variation of the set of business listings) may be assigned based on previous text-based search queries, such as Internet searches, SMS searches, etc, in which the textual data (or variants thereof) were used to search for the set of business listings. The weight or rank may, for example, be determined based on ranks assigned by the text search engine and/or based on other factors. For example, the weight or rank may be based on the actual business listings that users clicked (or selected or otherwise further inquired about) from the search results presented from a text-based search query. As an example, assume that a log of text-based queries and a log of user selections indicate that users performing a search with the search term Z click on Business A's listing 70% of the time, Business B's listing 20% of the time, and Business C's listing 3% of the time. The search engine 206 may thus generate and store a reference variation for word set Z that includes Business A with a weighting factor of, for example, 0.7, Business B with a weighting factor of 0.2, and Business C with a weighting factor of 0.03.

The search engine 206 may, in one embodiment, receive a speech recognition result (e.g., in the form of a reference variation) from speech recognition module 204 and perform a text-based search for information with the recognition result. In one embodiment, search engine 206 may use the recognition result to perform a search for one or more business listings. Any convenient and/or known searching techniques/algorithms may be used to identify a set of ranked and/or unranked results using the speech recognition result. For example, search engine 206 may compare the recognition result to entries in a database of business listings. Search engine 206 may assign rankings to one or more entries in the database based on a degree of matching between the recognition result and the entry.

FIG. 3 is a diagrammatic representation of how a voice user 308 and a text user 310 interacts with the system to obtain enhanced speech recognition results from text-based search queries.

The text user 310 may perform a text-based search query by submitting textual data 316 to a search engine 306. The search engine 306 may be associated with a database 330. The database 330 may store information that accessible by an external entity and/or an end user. For example, the database 330 may store data related to local business listings, national business listings, song information, stock information, weather information, flight information, movie listings, or any other type of information that may be searched by a user. The search engine 306 may retrieve information from the database 330 and provide the retrieved information, in the way of search results, to the text user 310. A log (e.g., text search log) may be generated by compiling a set of text-based search queries.

One or more reference variations are, in one embodiment, created for use in a set of grammars using the logs. For example, reference variations may be generated based on previously performed text searches and the terminology used in such text-based searches, including but not limited to, Internet searches, short message service (SMS) searches, or other text-based searches and stored in the set of grammars as grammar entries. As an example, assume that the search log indicates that search queries for “Dave's” in “Fairfax, Va.” are frequently looking for “Famous Dave's.” As such, a grammar entry may weigh Famous Dave's more heavily than other search results relating to “Dave's” in Fairfax, Va.

In one embodiment, the reference variations can be further stored in the database 330 for use by the search engine in searching. Thus, the reference variations may be stored in grammars, as grammar entries, for use in speech recognition and stored in the database 330 for use in query searches.

In one embodiment, the voice user 308 provides a voice query 314 to a speech recognizer 304. The speech recognizer 304 may use the grammars (which include the grammar entries created using logs) to obtain a recognition result. The speech recognizer 304 may provide the recognition result to the search engine 306. The search engine 306 may obtain a ranked or unranked list of results from the database 330 according to any known and/or convenient techniques. The search engine 306 may then provide one or more results 312 to the voice user (e.g., via a text-to-speech converter 302).

While the following description focuses on searches for business listings, it will be appreciated that the techniques described herein may be similarly or equally applicable to other types of searches. For example, embodiments consistent with the principles of the disclosure are contemplated to be applicable to searches for business listings and searches for any other type of information, by way of example but not limitation, songs, stock information, flight information, movie listings, sports scores, etc.

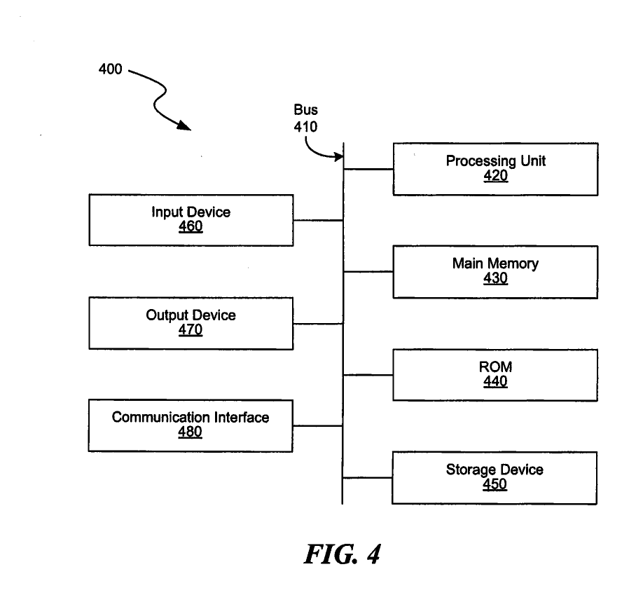

FIG. 4 depicts a block diagram illustrating example components of the host server 400.

The host server may include a bus 410, a processing unit 420, a main memory 430, a read only memory (ROM) 340, a storage device 450, an input device 460, an output device 470, and/or a communication interface 480. Bus 410 may include a path that permits communication among the server components.

Processing unit 420 may include a processor, microprocessor, or other type of processing logic that may interpret and execute instructions. Main memory 430 may include a random access memory (RAM) or another type of dynamic storage device that may store information and instructions for execution by processing unit 420. ROM 440 may include a ROM device or another type of static storage device that may store static information and instructions for use by processing unit 420. Storage device 350 may include a magnetic and/or optical recording medium and/or a corresponding drive.

The input device 460 may include a mechanism that permits an operator to input information to the client/server entity, such as a keyboard, a mouse, a pen, a microphone, voice recognition and/or biometric mechanisms, etc. Output device 470 may include a mechanism that outputs information to the operator, including a display, a printer, a speaker, etc. Communication interface 480 may include any transceiver-like mechanism that enables the client/server entity to communicate with other devices and/or systems. For example, communication interface 480 may include mechanisms for communicating with another device or system via a network.

As will be further illustrated, according to embodiments of the present disclosure, the host server may perform certain processing-related operations. The client/server entity may perform these operations in response to processing unit 420 executing software instructions contained in a computer-readable medium, such as memory 430. A computer-readable medium may be defined as a physical or logical memory device and/or carrier wave.

The software instructions may be read into memory 430 from another computer-readable medium, such as data storage device 450, or from another device via communication interface 480. The software instructions contained in memory 430 may cause processing unit 420 to perform processes that are described according to embodiments of this disclosure. Further, hardwired circuitry may be used in place of or in combination with software instructions to implement processes consistent with principles of the embodiments of the disclosure.

FIG. 5 illustrates a diagrammatic representation of the contents of a database 530 for storing reference variables (e.g., Business ID 514) and search terms (e.g., search query 512).

The database 530 is able to store reference variations listed under business ID 514 (which associate a search query (e.g., text-based search query) 512 with businesses 514 that may be referenced by a text-based search query 512). Database 530 may be associated with any number of geographical locales at the county, city, state, and/or country level. Larger or smaller geographical units may be used as location identifier 510 for which search queries 512 and the associated reference variations 514 are stored. The geographical units can include but are not limited to, a particular street, a particular alleyway, a neighborhood, a province, a continent, etc. In one embodiment, the database 530 may be partially or wholly internal or external to a host server (e.g., host server 224).

As illustrated, database 530 may include a location identifier (e.g., city identification (ID) field 510), a search query field 512, and a business identification field 514. It will be appreciated that database 530 may include additional fields than illustrated in FIG. 5. For example, database 500 may further include a user identification field. The user identification field can be used to specify user specific weight/rank information with respect to the reference variations associated with a particular text-based search query (e.g., Vincent's, Pizza, or Jack's). Based on user preferences or user-specific usage, one or more reference variations associated with a particular search query (e.g., Vincent's) may be ranked/weighed higher than others. These rankings and weightings may be different for different users or sets of users, for example.

The location identifier (e.g., the city identification field 510) uniquely identifies a geographical locale, as shown in this example, the state of Virginia. In the example of FIG. 5, database 530 illustrates the reference variations associated with the search terms “Vincent's”, “Pizza”, and “Jack's” for the geographical locale of the city of Fairfax. Text-based search query field 512 may store textual data that may be provided to the host server as part of a voice search query for reference on voice recognition purposes.

Reference variables-associated with various business listings (e.g., business identification field 514) that were and can be retrieved when a search query is made with the search term indicated in field 512. Generally, the various business listings that can be retrieved are determined based on complete or partial textual matches with the search query (e.g., “Vincent's”, “Pizza”, “Jack's”, etc).

In some embodiments, one or more business listings may be associated with a weight or rank. The weight or rank may be assigned to the business name by a text search engine, for example, based on how closely the name of the business matches the search query (search term). Alternatively, the weight or rank may be determined via other methods and are considered to be within the novel scope of this disclosure. For example, the weight/rank may be determined based on quantitative considerations such as the number of users who selected (or clicked) a particular listing (or reference variations) when a set of business listings (e.g., a set of reference variations) are presented as search results in response to the submitted search query.

The business identifier field 514 may store one or more business names (e.g., Jack's Autobody, Jack's Pizza, etc.) associated with a particular search query (e.g., Jack's) in search query field 512. In one embodiment, the business identification field 514 indicates one or more of the higher weighted or ranked business names matching the search query in search query field 512.

In a non-limiting example, the search query “Vincent's” matches a number of business names in part or in whole. Weights are assigned for at least some of the business names: Vincent's Pizza Park with a weight of 0.4, Vincent's Tire and Auto with a weight of 0.1, Vincent's Floral Designs with a weight of 0.03, etc. Thus, for the search query “Vincent's”, it is apparent that users performing text searches for “Vincent's” most often are searching for the reference variation of “Vincent's Pizza Park.” In the example illustrated in FIG. 5, the three higher ranked business names are included as part of the reference variation.

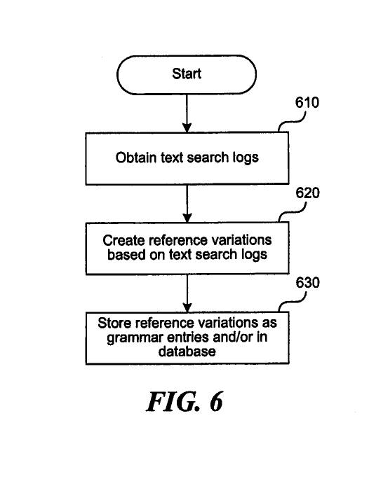

FIG. 6 depicts a flow diagram illustrating a process of creating reference variations from text-based search queries.

In process 610, text search logs are obtained and compiled. For example, logs of past searches including the text-based search query and the results presented in response of may be retained and recorded in a log. For example, text search logs may be generated or otherwise obtained from a server (or website) that provides text search services. The text search logs can, in some embodiments, include information identifying search queries (e.g., search terms) submitted by a voice or text user and the business names that were retrieved based on the search queries (i.e., the text search results). Moreover, the text search logs include the rank or weight assigned to one or more reference variations associated with business listings. The text search logs may further include information identifying the frequency with which one or more business listings is selected (or clicked) when a set of search results are presented-for a particular search query to a user.

In process 620, reference variations are created by analyzing the text search logs. With respect to creating reference variations for business searches, for example, compilations local business searches for a particular city or locale may be analyzed and reference variations may be determined based on the text-based search queries that were used. The text-based search queries can be identified and retrieved from the text search logs. For a text-based search query, text search results matching the search query partially or wholly can be stored. Rankings of one or more reference variations associated with business listings may be assigned.

In one embodiment, information representing the users' interactions with the search results are detected and recorded. User interactions may include, for example, which, if any, business listings were selected from the search results presented in response to the submitted search query. Reference variations may then be created, for example, from a set of matching search results.

For example, when the text search logs for a text-based search query of “Vincent's” in the city of “Fairfax, Va.” indicate that 70% of the time, users are searching for “Vincent's Pizza Park” (which may be indicated based on the frequency at which “Vincent's Pizza Park” is selected from a list of search results). Thus, a reference variation may be created for the search query “Vincent's” and the reference variation may associate a higher weight or rank with Vincent's Pizza Park. In one implementation, the weight or rank associated with Vincent's Pizza Park may be determined quantitatively, for example, based on the number of users selecting Vincent's Pizza Park in the search results. Other techniques for creating reference variations may alternatively be used.

In process 630, the reference variations are stored. For example, the reference variations may be stored in a grammar module as a grammar entry to facilitate speech recognition processes. In one embodiment, the reference variations may be stored in a database for searching purposes. The reference variations (stored in a grammar module and/or a database) may be associated with a particular city with which the text search logs from which the reference variations are created are associated. In some embodiments, the reference variations (stored in the grammar module and/or the database) are associated with a group of individuals or a single individual.

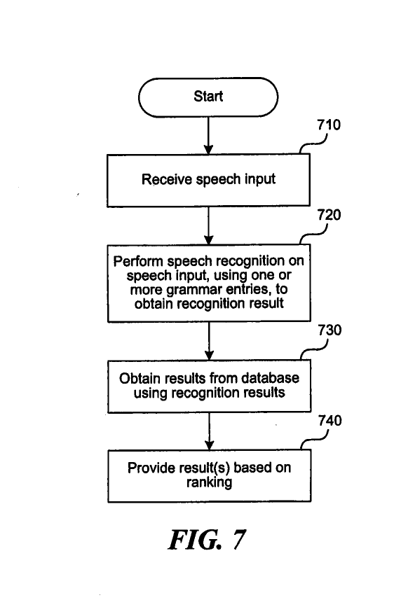

FIG. 7 depicts a flow diagram illustrating a process of providing enhanced search results by performing speech recognition and obtaining recognition results from grammar entries.

In process 710, audio input is received. The audio input may include by way of example but not limitation, voice input, speech input, recorded sound input, etc. For example, an audio input may comprise audio data received from a call. The caller may then be prompted for a city and a desired business listing. In response, the caller may provide the city and business listing in audio format.

In process 720, speech recognition is performed on the received audio input (e.g., speech or voice input) to obtain a speech recognition result. Any known speech recognition technique may be used to obtain the recognition result. For example, Hidden Markov Model (HMM) based technique may be applied to the audio to identify the word(s). In one embodiment, speech recognition is performed using a set of grammars that include grammar entries created using reference variations identified from text search logs.

In process 730, a list of business names are obtained using the recognition result and/or variations of the recognition result. For example, a database of business listings may be searched using the recognition result and can a ranked or unranked list of business listings are obtained Any known search technique may be used for obtaining the ranked list of business names. For example, a search engine may compare the recognition result to business names and may rank the business names in the database based on the comparison.

In process 740, the results are provided based on the rankings, if any. For example, a relatively higher ranked result may be provided. In one embodiment, one or more relatively higher ranked results are presented in an audible format. The results may alternatively or additionally be provided in other formats (e.g., textual format or other visual formats).

FIG. 8A illustrates a diagrammatic representation of the contents of another example database 830 for storing reference variables 814 and search terms 812.

In the example database 830, grammar entries are stored for business listings. As illustrated, a grammar entry may, for example, include geographical identifier field (e.g., a city identification (ID) field 810), an input field 812, and a reference variation field 814.

The geographical identifier field such as the city identification field 810 may store information that identifies a geographical locale (e.g., a town, a city, a state, a region, a country, etc.). In the example database 830, a grammar entry is associated with reference variations 830 for business listings in a particular city (e.g., the city of “Fairfax”). Input field 812 generally stores textual data that is submitted during an inquiry, for example, as part of a voice search query. Reference variation field 814 stores business listings that correspond to a particular search term (e.g., text-based search query) in the corresponding input field 820.

For example, database 830 includes grammar entries with the following reference variations:

walmart→WALMART

walmart stores→WALMART

joes pizza→JOES PIZZA

joes pizzeria→JOES PIZZA

clarkes charcoal broiler→CLAKES CHARCOAL BROILER

clarkes plumbing services→CLARKES PLUMBING SERVICES.

Thus, when an input of “clarkes charcoal broiler,” is received, for example, the input is recognized since a grammar entry exists for the input. However, an input of “clarkes,” may not be recognized since the input does not exist in grammar module for the input.

FIG. 8B illustrates a diagrammatic representation 850 of ranking/weighing of reference variation based on a text search log.

With further reference to the example of FIG. 8B, a text search log for a search query of “clarkes” in the city of “Fairfax, Va.” indicate that the majority of the time users are searching for “Clarke's Charcoal Broiler” (which may be indicated based on users selecting “Clarke's Charcoal Broiler” in a list of search results).

In example diagram 850, the text search logs indicate that 40% of the time that users search for “clarkes” in the city of “Fairfax, Va.,” the users is intending to look for Clarke's Charcoal Broiler and that 20% of the time the users are searching for Clarke's Plumbing Services. Thus, a reference variation may be created for the input “clarkes” and the reference variation may associate a higher weight or rank with Clarke's Charcoal Broiler and a next higher weight or rank to Clarke's Plumbing Services. In one embodiment, the reference variation “clarkes” may be added to the grammar module as a new grammar entry.

FIG. 8C illustrates a diagrammatic representation of the contents of another example database 830 for storing reference variables 824 and search terms (input 822).

In the example of FIG. 8C, a new grammar entry 840 may then be added to a grammar module for “clarkes.” Grammar entry 840 may associate the input of “clarkes” with Clarke's Charcoal Broiler with a weight, for example, of 0.4 and with Clarke's Plumbing Services with a weight of 0.2. Once added to grammar module, grammar entry 840 may be used to improve speech recognition, local business searches, etc. in the manner consistent with or similar to those described above.

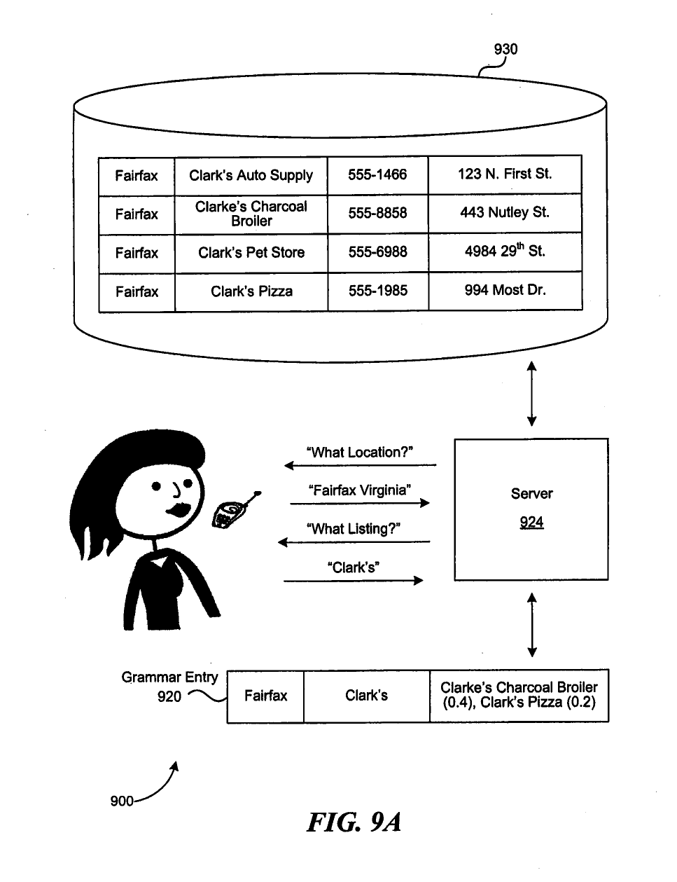

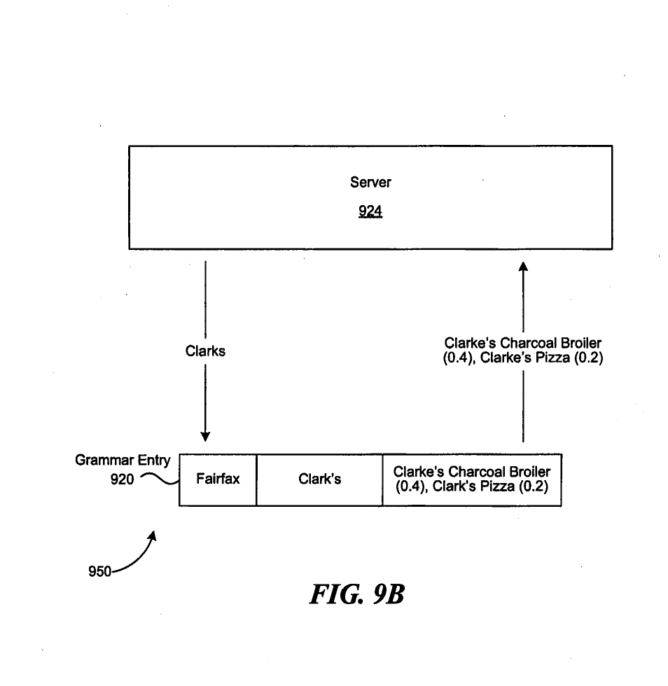

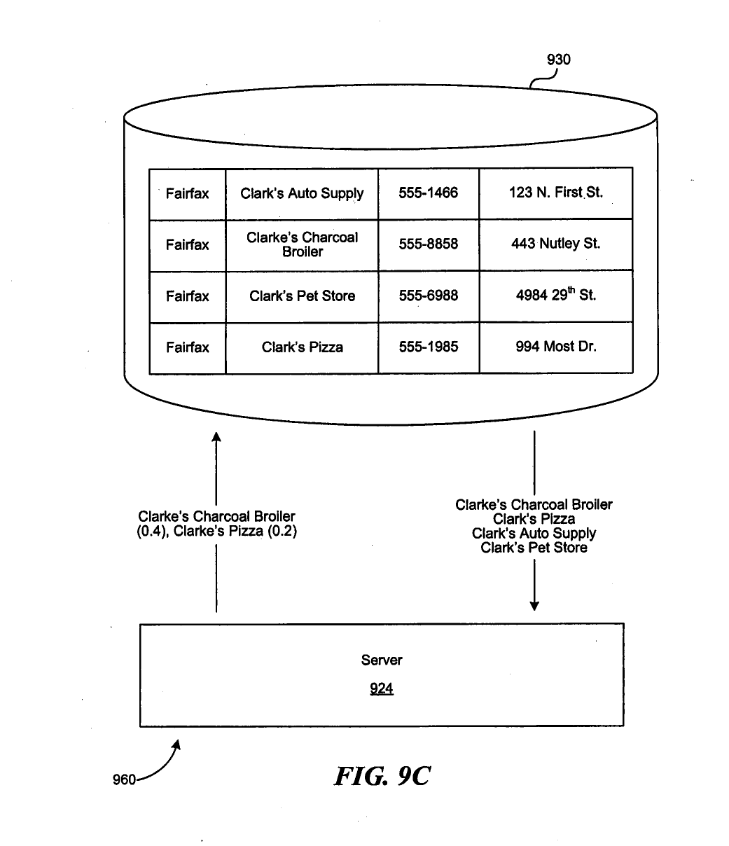

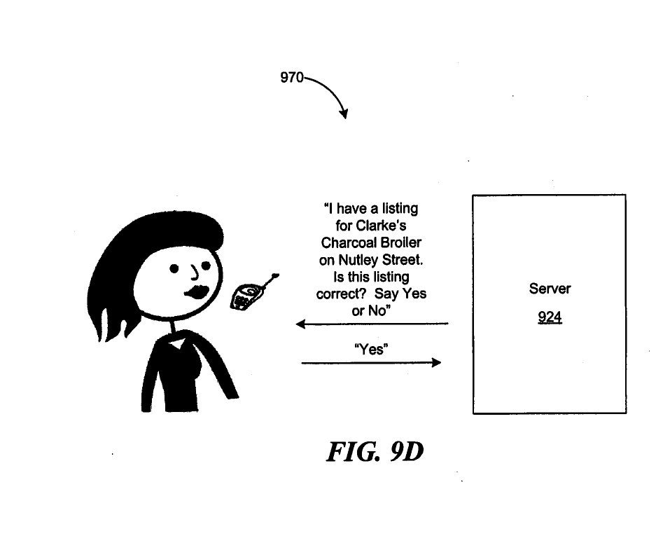

FIG. 9A-D illustrate diagrammatic representations 900, 950, 960, and 970 of user triggered access and modification of an example database 930 having a plurality of grammar entries.

In the example of FIG. 9A, a server 924 is associated with a database 930 and a grammar entry 920. When a user places a call to server 924 to obtain information regarding a business listing (e.g., a telephone number, an address, operation hours, location, etc.), the server 924 may prompt the user for the location (e.g., geographical identifier) of the business. Assuming that the user responds with “Fairfax Va.” or just “Fairfax.”, server 924 may perform speech recognition on the user's response and determine that the city in which the business is located is Fairfax. In response, server 924 may prompt the user for the name of the desired business listing.

Assume that the user responds with “Clark's”, the server 924 may perform speech recognition on the user's response using grammar entry 920, as illustrated with further reference to FIG. 9B. Using grammar entry 920, server 924 may obtain a recognition result for the input “Clark's.” In this example, the recognition result may include the reference variation including business names “Clarke's Charcoal Broiler” and “Clarke's Pizza” with weights of 0.4 and 0.2, respectively.

Server 924 may use the recognition result to obtain to a ranked or unranked list of businesses from database 930, as illustrated in FIG. 9C. In one embodiment, the server 924 ranks the list of businesses in the following order: Clarke's Charcoal Broiler, Clark's Pizza, Clark's Auto Supply, and Clark's Pet Store. Thus, the recognition result, which is based on grammar entry 920 of FIG. 9B, may cause Clarke's Charcoal Broiler to be one of the higher ranked result. In this way, logs from users performing local business text searches for “Clark's” in Fairfax, Va., may influence voice recognition results and subsequent voice searches.

Server 924 may provide the highest ranked business listing (i.e., Clarke's Charcoal Broiler) to the user, as illustrated in FIG. 9D. In some implementations, server 220 may ask the user if the provided business listing is correct. If the user answers affirmatively, then server 220 may provide additional information regarding the business to the user, such as an address, a telephone number, directions to the business, etc. If the user indicates that the business listing is incorrect, server 220 may, in some implementations consistent with principles of the invention, provide a next-highest ranked business listing to the user.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other methods, devices, and/or systems, not necessarily to those described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the device may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated.

In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. Accordingly, the inventors reserve the right to add additional claims after filing the application to pursue such additional claim forms for other aspects of the disclosure.

1. A method, comprising:
receiving a search request comprising a text-based search query;
identifying one or more search results that correspond to the text-based search query;
compiling a search log having a plurality of entries, wherein each entry of the plurality of entries is associated with the one or more search results and the text-search data;
creating a set of reference variations for the text-based search query, the set of reference variations to be created based on analyzing the one or more search results that correspond to the text-based search query;
storing the set of reference variations;
receiving a voice query from a requestor;
performing speech recognition to identify a speech recognition result; and
retrieving a reference variation from the set of reference variations based on the speech recognition result; and
providing the reference variation to the requestor in response to the voice query.

2. The method of claim 1, wherein the search request is submitted to locate a business listing.

3. The method of claim 1, wherein each reference variation of the set of reference variations is associated with the business listing.

4. The method of claim 1, further comprising, ranking each reference variation of the set of reference variations.

5. The method of claim 4, further comprising, ranking each reference variation based on rankings provided by a text search engine.

6. The method of claim 4, further comprising,
identifying a geographical location relevant to a particular text-based search query;
creating a plurality of grammar entries, each grammar entry of the plurality of grammar entries is associated with the particular text-based search query and a particular set of reference variations, wherein each grammar entry is identifiable by the geographical location relevant to the particular text-based search query; and
obtaining the speech recognition result based on one or more of the plurality of grammar entries.

7. The method of claim 1, wherein, the text-based search query is received via one or more of Internet search and SMS search.

8. A method, comprising:
receiving a text-based search query;
identifying one or more search results based on the text-based search query;
compiling a search log having a plurality of entries, wherein each entry of the plurality of entries includes the one or more search results and the text-search query; and
generating a set of reference variations for the text-based search query, the set of reference variations are created based on analyzing the one or more search results.

9. The method of claim 8, wherein the text-based search query is specific to a geographical location.

10. The method of claim 8, wherein the text-based search query is to identify a business listing.

11. The method of claim 8, wherein each reference variation of the set of reference variations is associated with the business listing.

12. The method of claim 10, further comprising, generating a grammar entry, the grammar entry comprising, one or more of the text-based search query, the geographical location associated with the text-based search query, and the set of reference variations.

13. The method of claim 8, further comprising, ranking one or more reference variations of the set of reference variations.

14. The method of claim 8, wherein, the text-based search query is received via one or more of Internet search and SMS search.

15. The method of claim 8, further comprising:
receiving a voice query; and
performing speech recognition on the voice query to identify a speech recognition result.

16. The method of claim 12, further comprising,
generating a plurality of grammar entries; and
weighting the plurality of grammar entries based on the one or more search results identified based on the text-based search query or user selection of the one or more search results.

17. The method of claim 15, further comprising, identifying variations of the speech recognition result using the set of reference variations.

18. The method of claim 17, further comprising, obtaining a list of business listings based on the variations of the speech recognition result.

19. A system, comprising:
a grammar module to store a set of reference variations created from one or more text search logs; wherein each of the set of reference variations is associated with a business listing and a geographical locale;
a speech recognition module to convert a speech signal to textual data; and
a search engine.

20. The system of claim 19, wherein the search engine compares the recognition result with the set of reference variations.
